(19) United States
(12) Patent Application Publication
(10) Pub. No.: US 2007/0197233 A1
(43) Pub. Date: Aug. 23, 2007

(54) Method of location-oriented call screening for communication apparatus

(75) Inventor: Yao Feng, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/520,721

(22) Filed: Sep. 14, 2006

(30) Foreign Application Priority Data
Feb. 20, 2006 (TW) 095105608

(51) Int. Cl. H04Q 7/20

(52) U.S. Cl. 455/456.4

(57) ABSTRACT

A method for location-oriented call screening on incoming calls by a communication apparatus comprises the steps of recording at least one piece of location information; extracting a piece of current site information; receiving an incoming call signal; determining whether said current site information matches at least one piece of said location information; and rejecting said incoming call when said current site information is determined to match said at least one piece of location information.

### FIELD OF THE INVENTION

The present invention relates to a method of location-oriented call screening of a communication apparatus and more particularly to a method of location-oriented call screening, wherein upon receiving an incoming call, a communication apparatus determines whether its site information matches a piece of pre-recorded location information and rejects said incoming call when said site information is determined to match said at least one piece of location information.

### BACKGROUND OF THE INVENTION

Riding the recent progress in network technologies to achieve low costs, compact sizes and full-fledged features, mobile phones (or cellular phones, cell phones) have become one of the most popular communication apparatus. With mobile phones, Users can exchange information for personal and business purposes almost anywhere and anytime. Hence the advantage of a mobile phone over a traditional chorded phone is apparent.

In current fast-paced life style, mobile phones are not only used as a convenient communication tool, it also provides numerous software accessories such as games, phone books, voice message boxes and alarm clocks to increase its functions as well as satisfy the high demand for a versatile machine.

Despite all the attractive features of mobile phones, drawbacks still exist in certain situations. A good portion of the working population attends meetings regularly. Incoming phone calls could be annoying or interrupting when people are, for example, in a business conference, studying or even just waiting for a piece of critical information. Concentration and attention could be seriously distracted in the above-mentioned circumstances by unexpected incoming calls and completion of jobs at hand significantly delayed, causing undesirable or detrimental consequences.

To deal with this problem, many cell phones provide a screening function for incoming calls. Names are pre-stored in the phone and a user can roughly categorize the names into a blacklist and a whitelist. The black list stores all the unwelcome names such that phone calls dialed by personnel in the black list are rejected by the phone. Unidentifiable phone calls may also be put into that category and be rejected. A whitelist on the other hand is a list of contacts that the user deems the calls from which are acceptable. This list is inclusionary and calls made by personnel not on the list are rejected. Brands such as BenQ, ASUS, XG and JMAS already have call screening function available in their cell phones. Mitsubishi M800 cell phones even offer selective screening function which combines the blacklist/whitelist scheme along with time and date checking in activating the function. For example, call screening function can be turned on and be effective for same day only, or it can be scheduled to be activated on a specific day of the week or on weekends only while setting certain contacts or groups of contacts (e.g. colleagues) are set in the whitelist.

Although periodical or one-time activation call screening function and contact list call screening function are implemented in said prior arts, the function may be inadvertently left on after the desirable screening period, resulting in critical phone calls missed and possible business opportunities lost.

### SUMMARY OF THE INVENTION

After considerable research and experimentation, a method of location-oriented call screening of a communication apparatus according to the present invention has been developed so as to overcome the drawbacks associated with said prior method.

It is an object of the present invention to provide a method of location-oriented call screening of a communication apparatus wherein upon receiving an incoming call, a communication apparatus determines whether extracted site information matches a piece of pre-recorded location information and rejects said incoming call when said site information is determined to match said at least one piece of location information.

The above and other objects, features and advantages of the present invention will become apparent from the following detailed description taken with the accompanying drawings.

### BRIEF DESCRIPTION OF THE DRAWINGS

FIG. 1 is a functional block diagram according to the present invention.

FIG. 2 shows the steps upon receiving an incoming call signal according to the present invention.

FIG. 3 is a flow chart of the site detecting unit and location recording unit according to the present invention.

FIG. 4 is a flow chart depicting the steps performed by the location recording unit in recording a piece of location information.

### DETAILED DESCRIPTION OF THE PREFERRED EMBODIMENTS

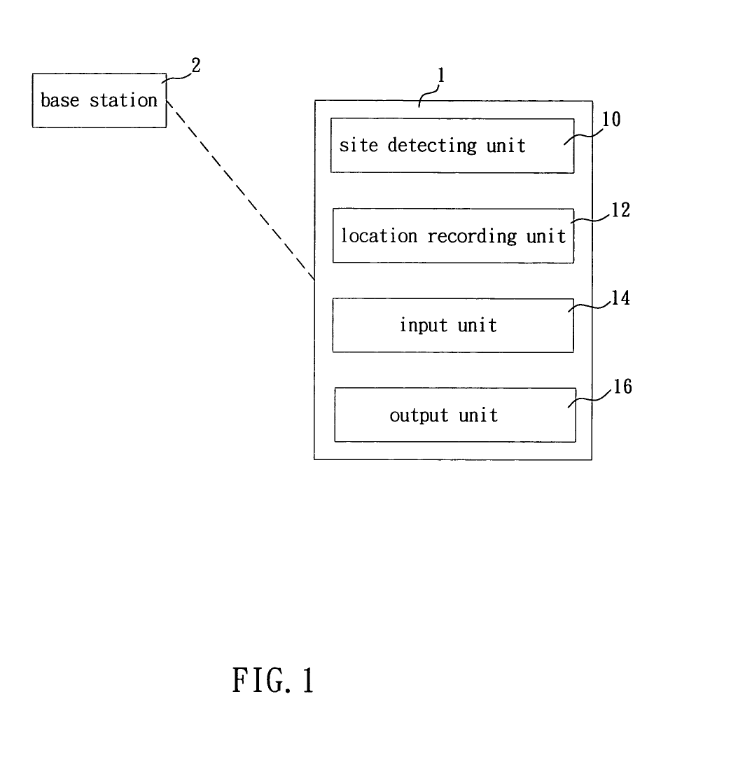

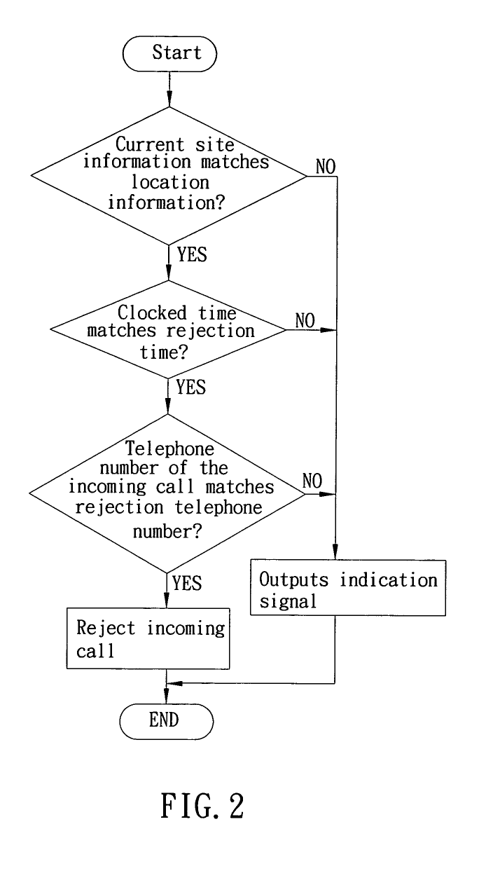

Refer to FIG. 1 and FIG. 2. When a communication apparatus 1 receives an incoming call signal, according to the comparison result of a current site information extracted from said communication apparatus 1 and a pre-recorded location information stored in said communication apparatus 1, said communication apparatus 1 cut off disconnects and rejects said incoming call when said current site information is determined to match said at least one piece of pre-recorded location information.

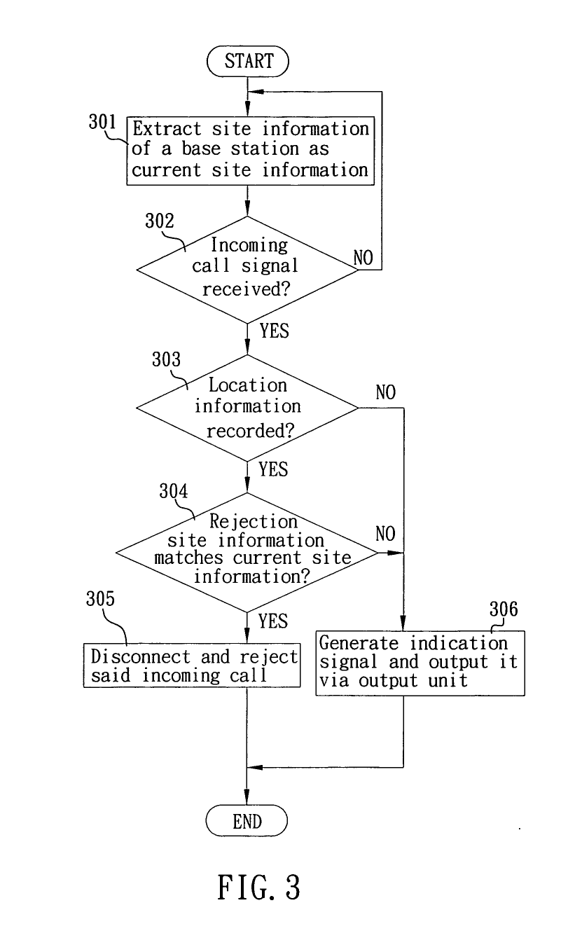

Refer to FIG. 1 and FIG. 3 for a preferred embodiment of the present invention. Said communication apparatus 1 comprises a site detecting unit 10 and a location recording unit 12. Said site detecting unit 12 is capable of extracting site information of a base station 2 currently connecting to said communication apparatus 1 and designating said site information as said current site information and said location recording unit 12 is capable of recording at least one piece of location information. Said location information comprises a location name inputted to an input unit 14 of said communication apparatus 1, and rejection site information corresponding to site information of a base station 2 connecting to the location designated by said location name. Said communication apparatus 1 performs the following steps to determine whether to disconnect and reject an incoming phone call.
(301) Said site detecting unit 10 extracts site information of a base station 2 currently connecting to said communication apparatus 1 and designating said site information as said current site information.
(302) Determining whether an incoming call signal is received; if so, go to step (303), else go to step (301).
(303) Determining whether at least one piece of location information is recorded in said location recording unit 12; if so, go to step (304), else go to step (306).
(304) Determining whether said rejection site information matches said current site information; if so, go to step (305), else go to step (306).
(305) Disconnecting and rejecting said incoming call.
(306) Generating an indication signal and output said indication signal via an output unit 16.

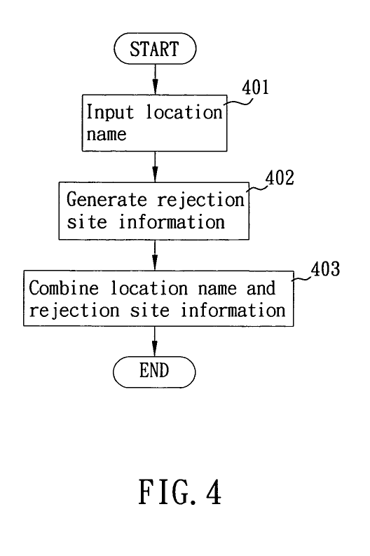

Refer to FIG. 1 and FIG. 4 for said preferred embodiment. Said location recording unit 12 of said communication apparatus 1 records said at least one piece of location information with the following steps.
(401) Through said input unit 14, input at least a letter or a character to said communication apparatus 1 as said location name.
(402) Said site detecting unit 10 extracts site information of a base station 2 currently connecting to said communication apparatus 1 to generate a rejection site information.
(403) Combining said location name and said rejection site information and storing said new information in said location recording unit 12.

In said preferred embodiment, said communication apparatus can be a GSM cell phone, the site detecting unit 10 of said GSM cell phone extracts information in a home location register (HLM) contained in said GSM cell phone to obtain site information of a base station 2 currently connecting to said communication apparatus 1.

Refer to FIG. 1 and FIG. 2 for another preferred embodiment. When said communication apparatus 1 determines that said current site information matches said at least one piece of location information, said communication apparatus 1 compares the time kept by an internal clock on said communication apparatus 1 with a rejection time period stored in said communication apparatus and rejects said incoming call when a match between said clocked time and said rejection time is determined. Otherwise said communication apparatus 1 outputs an indication signal via said output unit 16.

In yet another preferred embodiment, when said communication apparatus 1 determines that said current site information matches said at least one piece of location information and said clocked time matches said rejection time, said communication apparatus 1 further compares a telephone number of the incoming call with said rejection telephone number stored in said communication apparatus 1 and rejects said incoming call when a match between said telephone number of the incoming call and said rejection telephone number is determined. Otherwise said communication apparatus 1 outputs an indication signal via said output unit 16.

The above descriptions conclude that communication apparatus 1 can selectively accept or reject an incoming call according to the location of the call, the time of the call and the phone number of the call. Only when said communication apparatus 1 is situated at that specific location, at that particular time period with a particular calling number will an incoming call be rejected. If said communication apparatus 1 is not situated at that specific location, but the time and phone number match the criteria, said output unit 16 still sends out an indication signal so that the effectiveness of call screening by said communication apparatus is improved.

While the invention herein disclosed has been described by means of specific embodiments, numerous modifications and variations could be made thereto by those skilled in the art without departing from the scope and spirit of the invention set forth in the claims.

What is claimed is:

1. A method of location-oriented call screening, which is implemented to a communication apparatus including a site detecting unit and a location recording unit, comprising the steps of:
recording at least one location information;
extracting a current site information of said communication apparatus;
receiving an incoming call signal;
determining whether said current site information matches said at least one recorded location information; and
rejecting said incoming call when said current site information is determined to match said at least one recorded location information.

2. The method of claim 1, wherein said site detecting unit extracting site information from a base station connecting to said communication apparatus and designating said site information as said current site information, and said location recording unit recording said at least one location information.

3. The method of claim 2, further comprises the step of inputting said at least one location information through an input unit of said communication apparatus.

4. The method of claim 3, wherein said at least one recorded location information comprises a location name and corresponding rejection site information, said rejection site information being corresponding to site information of a base station in the location designated by said location name.

5. The method of claim 4, wherein upon receiving an incoming call signal, further comprises the step of determining whether said location recording unit stores said at least one location information.

6. The method of claim 5, wherein upon recording said at least one location information, further comprises the steps of:
inputting at least a letter or a character as said location name;
extracting said site information of said base station currently connecting to said communication apparatus to generate said rejection site information; and
combining said location name and said rejection site information and storing the same in said location recording unit.

7. The method of claim 6, wherein when determining said current site information matches said at least one location information, further comprises the steps of:
comparing a clocked time on said communication apparatus with a rejection time period stored in said communication apparatus; and
rejecting said incoming call when a match is determined.

8. The method of claim 6, wherein when determining said current site information matches said at least one recorded location information, further comprises the steps of:
comparing a clocked time on said communication apparatus with a rejection period stored in said communication apparatus;
when a match is determined, comparing a telephone number of the incoming call with a rejection telephone number of said communication apparatus; and
rejecting said incoming call when a match is determined.
